(19) United States
(12) Patent Application Publication
(10) Pub. No.: US 2008/0236743 A1
(43) Pub. Date: Oct. 2, 2008

(54) APPARATUS FOR REMOVING A POLARIZER AND METHOD THEREOF

(75) Inventors: Myeong-Ha KYE, Seoul (KR); Seung-Ju LEE, Gwangmyeong-si (KR); Yun JANG, Suwon-si (KR); Seung-Hee LEE, Seoul (KR); Joon-Hyung PARK, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Seoul (KR)

(21) Appl. No.: 12/050,349

(22) Filed: Mar. 18, 2008

(30) Foreign Application Priority Data
Apr. 2, 2007 (KR) 2007-0032256

(51) Int. Cl. B32B 38/10

(52) U.S. Cl. 156/344; 156/584

(57) ABSTRACT

An apparatus for removing a polarizer of a liquid crystal display includes a roller portion including a rotating exfoliating roller and a gripping portion disposed on the exfoliating roller and gripping an edge of the polarizer, and a roller moving portion exfoliating the polarizer from a liquid crystal panel, the roller moving portion rotating and moving the roller portion. A rotating direction of the exfoliating roller is the same as a moving direction of the exfoliating roller.

This application claims priority to Korean Patent Application No. 10-2007-0032256 filed on Apr. 2, 2007, and all the benefits accruing therefrom under 35 U.S.C. §119, the entire contents of which are incorporated herein by reference.

### BACKGROUND OF THE INVENTION

(a) Field of the Invention

The present invention relates to an apparatus for removing a polarizer and a method thereof.

(b) Description of the Related Art

Liquid crystal displays (“LCDs”) are one of the most widely used flat panel displays. An LCD includes a pair of panels provided with field-generating electrodes, such as pixel electrodes and a common electrode, and a liquid crystal (“LC”) layer interposed between the two panels. The LCD displays images by applying voltages to the field-generating electrodes to generate an electric field in the LC layer. The electric field determines the orientations of LC molecules therein to adjust polarization of incident light. In the LCD, a pair of polarizers for forming polarized incident light with a predetermined direction are attached to the outer surfaces of the LC panel, thereby usefully displaying images.

In the manufacturing process of the liquid crystal display, when the attachment of the polarizers becomes bad due to bubbles or foreign substances formed between the polarizers and the LC panel, the attached polarizers are detached using an apparatus for removing a polarizer and new polarizers are attached using an apparatus for attaching a polarizer.

According to a thin type LCD, the thickness of the polarizers is thin. However, if the thickness of the polarizer is too thin, when removing the polarizers from the LC panel by using an apparatus for removing a polarizer, the polarizers tear easily. To prevent this problem, a method of reducing the velocity for separating the polarizers from the LC panel is provided. However, the total process time is increased, thereby reducing productivity.

### BRIEF SUMMARY OF THE INVENTION

An exemplary embodiment provides an apparatus for removing a polarizer having improved productivity and good process yields.

An exemplary embodiment of the apparatus for removing a polarizer includes a roller portion including a rotating exfoliating roller and a gripping portion disposed on the exfoliating roller and gripping an edge of the polarizer, and a roller moving portion exfoliating the polarizer from a liquid crystal panel. The roller moving portion rotates and moves the roller portion. A rotating direction of the exfoliating roller is the same as a moving direction of the exfoliating roller. The exfoliating roller rotates at a rotating velocity and moves at a moving velocity.

In an exemplary embodiment, an upper surface of the exfoliated polarizer is contacted with a rear surface of an outer circumference of the exfoliating roller with reference to the moving direction of the exfoliating roller.

In an exemplary embodiment, the exfoliating angle is defined as an angle between the exfoliated polarizer and the polarizer attached to the liquid crystal panel. The roller moving portion controls the exfoliating angle through adjustment of the rotating velocity and the moving velocity.

In an exemplary embodiment, the apparatus may further include a stage portion disposed under the liquid crystal panel and fixing the liquid crystal panel. The stage portion may include a plurality of openings disposed under and fixing the liquid crystal panel and fixing.

An exemplary embodiment of a method of removing a polarizer of a liquid crystal display includes rotating in a rotating direction at a rotating velocity and horizontally moving in a moving direction at a horizontally moving velocity an exfoliating roller and exfoliating a polarizer from a liquid crystal panel with a first exfoliating angle, controlling the rotating velocity and the horizontally moving velocity, and exfoliating the polarizer from the liquid crystal panel with a second exfoliating angle less than the first exfoliating angle, and maintaining a third exfoliating angle, and exfoliating the polarizer from the liquid crystal panel. The rotating direction of the exfoliating roller is the same as the moving direction of the exfoliating roller.

In an exemplary embodiment an upper surface of the exfoliated polarizer is contacted with a rear surface of an outer circumference of the exfoliating roller with reference to the moving direction of the exfoliating roller.

An exemplary embodiment of a method of removing a polarizer of a liquid crystal display includes rotating an exfoliating roller with a first rotating velocity, moving the exfoliating roller with a first horizontal moving velocity, and exfoliating a polarizer from a liquid crystal panel, rotating the exfoliating roller with a second rotating velocity smaller that the first rotating velocity, moving the exfoliating roller with a second horizontal moving velocity, and exfoliating the polarizer from the liquid crystal panel, and rotating the exfoliating roller with a third rotating velocity greater that the second rotating velocity, moving the exfoliating roller with a third horizontal moving velocity, and exfoliating the polarizer from the liquid crystal panel.

In an exemplary embodiment the first, the second and the third horizontal moving velocity are equal to each other.

In an exemplary embodiment the second rotating velocity is slower than the second horizontal moving velocity of the exfoliating roller.

In an exemplary embodiment an exfoliating angle is defined as an angle between the exfoliated polarizer and the polarizer attached to the liquid crystal panel. An exfoliating angle of the exfoliating at the second rotating velocity is reduced from an exfoliating angle of the exfoliating at the first rotating velocity.

In an exemplary embodiment the second rotating velocity is about zero.

In an exemplary embodiment the first and third rotating velocities are the same as the first, the second and the third horizontal moving velocity of the exfoliating roller.

An exemplary embodiment of a method of removing a polarizer of a liquid crystal display includes a first exfoliating step of exfoliating a polarizer from a liquid crystal panel, the first exfoliating including moving an exfoliating roller with a first horizontal moving velocity and a first rotating velocity, a second exfoliating of the polarizer from the liquid crystal panel, the second exfoliating including moving the exfoliating roller with a second rotating velocity, and a second horizontal moving velocity greater than the first horizontal moving velocity, and a third exfoliating of the polarizer from the liquid crystal panel, the third exfoliating including moving the exfoliating roller with a third rotating velocity, and a third horizontal moving velocity slower than the second horizontal moving velocity.

In an exemplary embodiment the first, the second and the third rotating velocity are equal.

In an exemplary embodiment the second horizontal velocity is greater than the first, the second and the third rotating velocity of the exfoliating roller.

In an exemplary embodiment an exfoliating angle is defined as an angle between the exfoliated polarizer and the polarizer attached to the liquid crystal panel. An exfoliating angle of the second exfoliating is reduced from an exfoliating angle of the first exfoliating.

In an exemplary embodiment the first and third horizontal moving velocities are the same as the first, the second and the third rotating velocity of the exfoliating roller.

### BRIEF DESCRIPTION OF THE DRAWINGS

The present invention will become more apparent by describing exemplary embodiments thereof in detail with reference to the accompanying drawings.

FIG. 1A is a perspective view of an exemplary embodiment of a polarizer remover of a liquid crystal display according to the present invention.

FIGS. 1B and 1C are enlarged views of the portions B and C of FIG. 1A

FIG. 2 is an enlarged view of the polarizer exfoliating roller and an exfoliated polarizer shown in FIGS. 1A-1C.

FIG. 3 to FIG. 7 are sequential views illustrating an exemplary embodiment of a method of removing a polarizer using a polarizer exfoliating roller of a polarizer remover according to the present invention.

FIG. 8 is a plane view showing the removing method of FIG. 3 to FIG. 7.

FIG. 9 and to FIG. 10 are sequential views showing another exemplary embodiment of a method of removing a polarizer using a polarizer exfoliating roller of a polarizer remover according to the present invention.

### DETAILED DESCRIPTION OF THE INVENTION

The present invention will be described more fully hereinafter with reference to the accompanying drawings, in which exemplary embodiments of the invention are shown. The present invention may, however, be embodied in many different forms and should not be construed as limited to the embodiments set forth herein.

It will be understood that when an element or layer is referred to as being “on” or “coupled to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “under,” “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

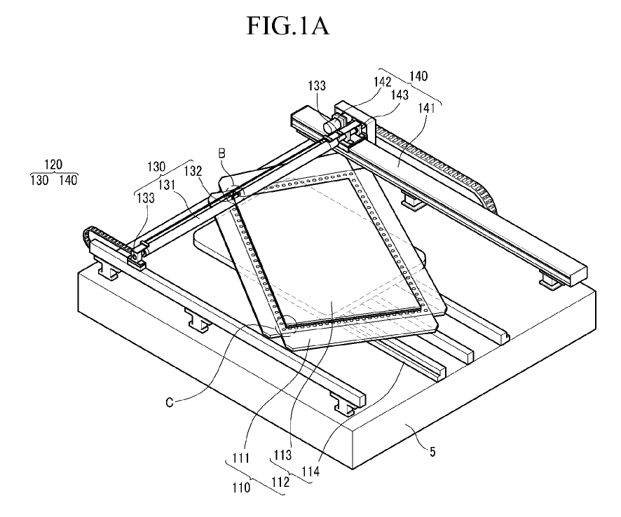

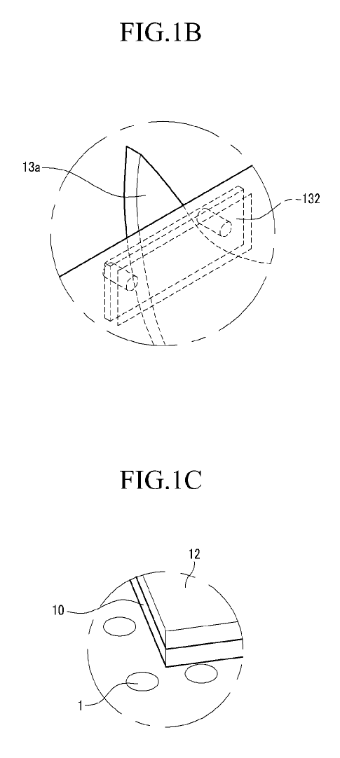

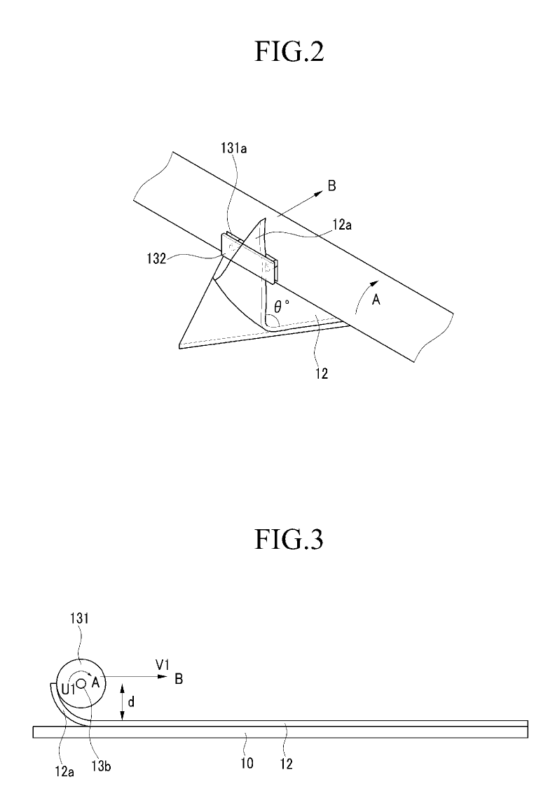

Now, an exemplary embodiment of an apparatus for removing a polarizer according to the present invention will be described in detail with reference to FIGS. 1 and 2.

FIG. 1A is a perspective view of an exemplary embodiment of a polarizer remover of a liquid crystal display according to the present invention, FIGS. 1B and 1C are enlarged views of the portions B and C of FIG. 1A, and FIG. 2 is an enlarged view of the polarizer exfoliating roller and the exfoliated polarizer shown in FIG. 1A-1C.

As shown in FIGS. 1A-1C and FIG. 2, a polarizer remover (e.g., an apparatus for removing a polarizer) of a liquid crystal display includes a stage portion 110 and an exfoliating portion 120. The stage portion 110 absorbs or fixes a liquid crystal panel 10 while a polarizer is being removed. The state portion 110 may be disposed on a base plate 5, as illustrated in FIG. 1A. The exfoliating portion 120 exfoliates a defective polarizer 12, such as one being poorly attached to the liquid crystal panel 10. The exfoliating portion 120 is detached (e.g., separated) from the stage portion 110 at a predetermined interval or distance.

A plurality of absorbing holes 1 are formed in the stage portion 110. The stage portion 110 includes a supporting portion 111, such as for securing or holding the liquid crystal panel 10, and a moving support portion 112, such as for moving the supporting portion 111, for example, in up/down, right/left and rotating directions.

The absorbing holes 1 reduce or effectively prevent the liquid crystal panel 10 from moving, such as by vacuum-absorbing the liquid crystal panel 10, when exfoliating the polarizer 12 from the liquid crystal panel 10. Advantageously, the absorbing holes 1 allow the polarizer 12 to be easily exfoliated from the liquid crystal panel 10.

The moving support portion 112 includes a moving plate 113 located under the supporting portion 111 (as shown in partial dotted lines in FIGS. 1A-1C), and a plurality of moving rails 114 connected to the moving plate 113 and guiding the moving plate 113 in a predetermined direction. Advantageously, the moving support portion 112 provides a convenience to workers by moving the supporting portion 111 to comfortable working positions, such that the process for removing the polarizer is relatively easily executed.

The exfoliating portion 120 includes a roller portion 130 and a roller moving portion 140 which moves the roller portion 130, such as rotating and moving the roller portion 130. The roller portion 130 includes an exfoliating roller 131 which is rotated, a gripping or catching portion 132 installed on the exfoliating roller 131, such as substantially in a center of the roller 131, and catching the edge of the polarizer 12, and a pair of air cylinders 133 controlling the opening and closing of the catching portion 132.

In the illustrated embodiment of FIG. 2, if the catching portion 132 of the exfoliating roller 131 is in an opened position, a gap or opening 131a is formed. The edge of the polarizer 12 is disposed in the opening 131a and is caught by placing the catching portion 132 in a closed position and closing the opening 131a. The exfoliated polarizer 12a is held or gripped in the catching portion 132. The pair of air cylinders 133 are installed on ends of the exfoliating roller 131. The opening and closing of the catching portion 132 to catch the edge of the polarizer 12 is executed by actions of the air cylinders 133.

The roller moving portion 140 includes a moving controller 141 guiding the movement and moving the roller portion 130, such as in front and rear directions, a first driving portion 142 providing the driving force to the moving controller 141, and a second driving portion 143 connected to the central axis of the exfoliating roller 131 and rotating the exfoliating roller 131.

In an exemplary embodiment, the moving controller 141 includes a pair of guide rails, and/or the first and second driving portions 142 and 143 are driving motors. The exfoliating roller 131 is rotated with a prescribed velocity, such as by the action of the first driving portion 142 with respect to the central axis thereof. The exfoliating roller 131 is moved in front and rear (e.g., back and forth) directions with a prescribed velocity by the moving controller 141 and the second driving portion 143.

As in the illustrated embodiment, the upper surface of the exfoliated polarizer 12a is contacted with a rear surface portion of the circumference of the exfoliating roller 131, with reference to the moving direction B of the exfoliating roller 131 in FIG. 2. In the exemplary embodiment, the rotation direction A of the exfoliating roller 131 is the same as the moving direction B of the exfoliating roller 131.

If the lower surface of the exfoliated polarizer 12, which is contacted with the liquid crystal panel 10, is contacted with a front surface portion of the circumference of the exfoliating roller 131 with reference to the moving direction B of the exfoliating roller 131, and the rotation direction A of the exfoliating roller 131 is opposite to the moving direction B, the exfoliating angle θ between the exfoliated polarizer 12 and the polarizer 12 attached to the liquid crystal panel 10 is reduced. However, if the exfoliating angle θ is reduced, the ratio of the force required to exfoliate the polarizer 12 by overcoming the adhesion of the polarizer 12 to the liquid crystal panel 10 and the tension applied to the exfoliated polarizer 12a is reduced.

When vector-analyzing the tension applied to the exfoliated polarizer 12a with the components perpendicular and parallel to the surface of the liquid crystal panel 10, the perpendicular component of the tension is primarily used or effectively only used as the force to exfoliate the polarizer 12. Accordingly, when the exfoliating angle θ is reduced and the tension applied to the exfoliated polarizer 12a to exfoliate the polarizer 12 attached to the liquid crystal panel 10 must be increased, the possibility of tearing the polarizer 12 is increased.

As in the illustrated embodiment of the polarizer remover of a liquid crystal display according to the present invention, the upper surface of the exfoliated polarizer 12 is contacted with the rear surface portion of the circumference of the exfoliating roller 131 with reference to the moving direction B of the exfoliating roller 131, and the rotation direction A of the exfoliating roller 131 is the same as the moving direction B of the exfoliating roller 131. Since the exfoliating angle θ becomes about 90 degrees, most of the tension applied to the exfoliated polarizer 12a is used as a force to exfoliate the polarizer 12 attached to the liquid crystal panel 10. Advantageously, the tension applied to the exfoliated polarizer 12a to exfoliate the polarizer 12 attached to the liquid crystal panel 10 may be minimized such that the polarizer 12 is not significantly torn.

Furthermore, the exfoliating angle θ may be controlled by controlling the rotation velocity of the exfoliating roller 131. As in the exemplary embodiment, the first driving portion 142 of the roller moving portion 140 control the rotation velocity. The exfoliating angle θ may also be controlled by controlling the movement velocity of the exfoliating roller 131 along with moving controller guide 141, such as controlling the second driving portion 143 of the roller moving portion 140. Advantageously, the exfoliating angle θ may be controlled by simultaneously controlling the first and second driving portions 142 and 143 such that the tension applied to the polarizer 12 may be minimized.

Now, an exemplary embodiment of a method of removing a polarizer using an apparatus for removing a polarizer according to the present invention will be described in detail with reference to FIG. 1A to FIG. 8.

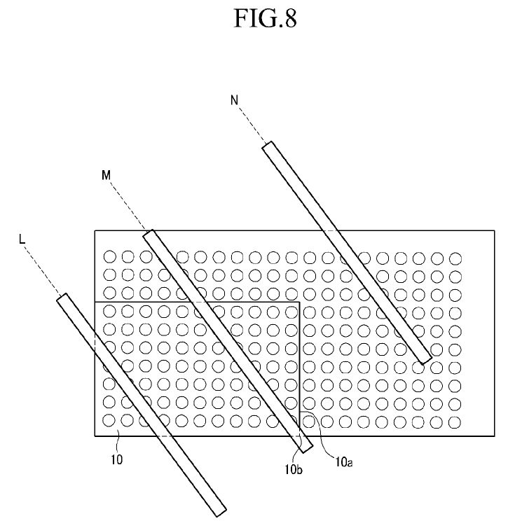

FIG. 3 to FIG. 7 are sequential views showing an exemplary embodiment of a method of removing a polarizer using the polarizer exfoliating roller of a polarizer remover according to the present invention, and FIG. 8 is a plane view showing the removing method of FIG. 3 to FIG. 7.

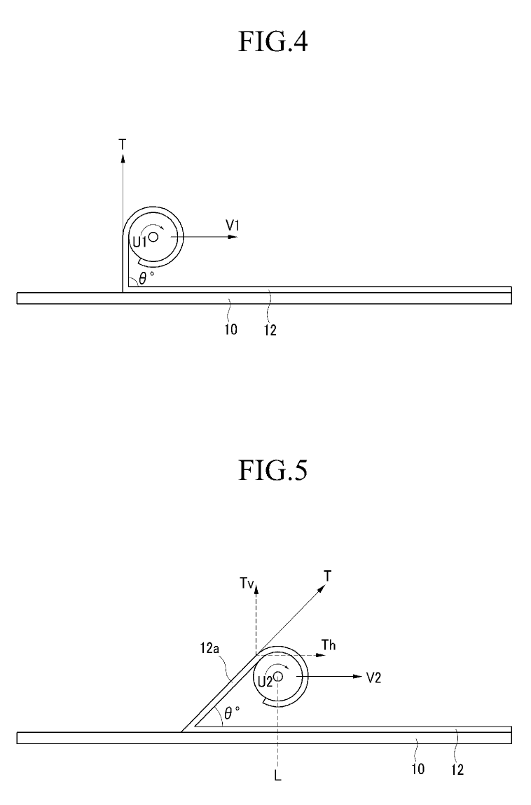

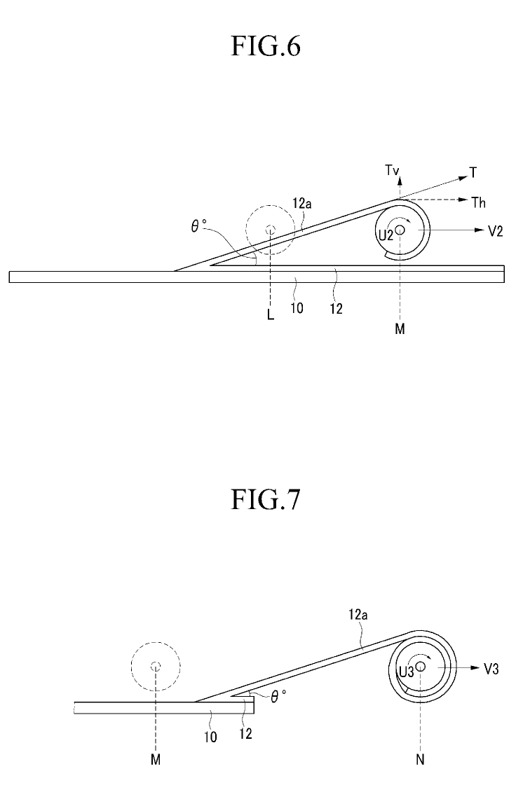

FIG. 3 and FIG. 4 are views showing initial exfoliating steps, FIG. 5 and FIG. 6 are views showing intermediate exfoliating steps, and FIG. 7 is a view showing a final exfoliating step.

Referring to FIG. 3, in an initial exfoliating step, the roller portion 130 of the polarizer remover 100 opens and closes the catching portion 132, such as by using the air cylinders 133 at both ends of the roller 131, and grips a corner and/or an edge of the polarizer 12.

With the roller portion 130 having caught the edge of the polarizer 12 using the catching portion 132, the exfoliating roller 131 is rotated with a prescribed rotation velocity U1 with reference to the central axis of the exfoliating roller 131, such as by the first driving portion 142. Substantially simultaneously, the exfoliating roller 131 is moved in a lateral (e.g., horizontal) direction with a horizontal moving velocity V1, such as by the second driving portion 143. The rotating of and the lateral movement of the exfoliating roller 131 exfoliates the polarizer 12 from the liquid crystal panel 10.

During the rotating and lateral movement of the exfoliating roller 131, the upper surface of the exfoliated polarizer 12a is contacted with the rear surface of the circumference of the exfoliating roller 131. The distance d between the central axis of the exfoliating roller 131 and the upper surface of the polarizer 12 is maintained to reduce or effectively prevent contact between the exfoliating roller 131 and the polarizer 12 attached to the liquid crystal panel 10. In exemplary embodiments, the distance d may be maintained throughout the subsequent processes, as in the illustrated embodiment. The rotation velocity U1 of the exfoliating roller 131 is used herein to indicate the moving velocity of the circumference according to the rotation of the exfoliating roller 131. In an exemplary embodiment, the rotation velocity U1 of the exfoliating roller 131 may be the same as the horizontal moving velocity V1, however, the invention is not limited thereto.

Referring to FIG. 4, the exfoliating roller 131 is continuously rotated and moved with the rotation velocity U1, and the horizontal moving velocity V1. Since the upper surface of the exfoliated polarizer 12a is contacted with the rear surface of the circumference of the exfoliating roller 131, and since the rotation direction A of the exfoliating roller 131 is the same direction as the moving direction B of the exfoliating roller 131, the exfoliating angle θ is maintained, such as at about 90 degrees. In the illustrated embodiment, the tension T applied to the exfoliated polarizer 12a may be minimized such that the exfoliated polarizer 12a is not significantly torn. Furthermore, as shown in FIG. 8, since the liquid crystal panel 10 is securely held, such as by being vacuum-absorbed by the vacuum (e.g., absorption) holes 1 of the stage portion 110, premature or undesirable lifting of the liquid crystal panel 10 may be reduced or effectively prevented while the polarizer is exfoliating from the liquid crystal panel 10.

However, when the exfoliating roller 131 arrives at the position M (FIG. 6) in the intermediate exfoliating step, since the absorption holes 1 disposed on the portion corresponding to the (e.g., right) lower edge 10a (FIG. 8) or the (e.g., right) lower corner 10b (FIG. 8) of the liquid crystal panel 10 do not completely vacuum-absorb the liquid crystal panel 10, undesirable lifting of the liquid crystal panel 10 may be generated when exfoliating the polarizer 12. The number of absorption holes 1 holding the liquid crystal panel 10 is relatively small on a portion of the liquid crystal panel 10 corresponding to the right lower edge 10a or the right lower corner 10b, and so the fixing or vacuum force is reduced. Since the substantially perpendicular component force of the tension applied to the polarizer 12 attached to the liquid crystal panel 10 is larger than the vacuum-absorption force holding the liquid crystal panel 10, premature of the liquid crystal panel 10 may be generated when exfoliating the polarizer 12. To reduce or effectively prevent this problem, as shown in FIG. 5, the exfoliating angle θ is reduced to increase the horizontal component force of the tension applied to the polarizer 12 in the intermediate exfoliating step, which will now be described in detail.

As shown in FIG. 5, the rotation velocity U2 of the exfoliating roller 131 in the intermediate exfoliating step is smaller than the rotation velocity U1 of the initial exfoliating step (FIGS. 3 and 4), and the polarizer 12 is exfoliated. In exemplary embodiments, it is preferable that the rotation velocity U2 of the intermediate exfoliating step is smaller than the rotation velocity U1 of the initial exfoliating step or is zero, and that the horizontal moving velocity V2 of the intermediate exfoliating step is substantially the same as the horizontal moving velocity V1 of the initial exfoliating step (FIGS. 3 and 4).

Since the exfoliating angle θ at the position L (FIGS. 5 and 8) in the intermediate exfoliating step is smaller than the exfoliating angle θ in the initial exfoliating step (FIGS. 3 and 4), the horizontal tension component Th is increased and the vertical tension component Tv is reduced among the tension T applied to the polarizer 12. However, the horizontal tension component Th may against or opposite to movement of the liquid crystal panel 10 in the horizontal direction. When the liquid crystal panel 10 lifts, a reaction is generated against the horizontal tension component Th in the opposite direction such that the lifting of the liquid crystal panel 10 is frustrated or effectively prevented. In the illustrated embodiment according to the present invention, since the rotation velocity U2 of the intermediate exfoliating step is approximately zero, the exfoliating roller 131 shown in FIG. 5 and FIG. 6 is not rotated.

Referring to FIG. 6 and FIG. 8, the exfoliating roller 131 is continuously rotated and moved with the rotation velocity U2 and the horizontal moving velocity V2. Until the portion of the exfoliating roller 131 arrives at the position M corresponding to the right lower edge 10a or the right lower corner 10b of the liquid crystal panel 10a, the minimized exfoliating angle θ is maintained. When the vacuum force of the absorption holes 1 is reduced at the position M, the undesirable lifting of the liquid crystal panel 10 may be reduced or effectively prevented by increasing the horizontal tension component Th (such as is indicated by the relatively longer dotted arrow of Th in FIG. 6). If the exfoliating angle θ is relatively extremely small, tearing of the polarizer 12 may be generated. In exemplary embodiments, it is preferable that the exfoliating angle θ is adjusted and reduced until just before tearing of the polarizer 12 occurs or would occur.

Referring to FIG. 7 and FIG. 8, the rotation velocity U3 of the exfoliating roller 131 in a final exfoliating step (e.g., at the position N) is increased to be larger than the rotation velocity U2 of the intermediate exfoliating step (FIGS. 5 and 6), directly after passing the position M. At the position M, the absorption force of the absorption holes 1 may be reduced, and the horizontal moving velocity V3 of the final exfoliating step is substantially the same as the horizontal moving velocity V2 of the intermediate exfoliating step.

Since the rotation velocity U3 of the exfoliating roller 131 in the final exfoliating step is greater than the rotation velocity U2 of the intermediate exfoliating step, the exfoliating roller 131 winds the exfoliated polarizer 12a, e.g., onto the roller, with a greater velocity. If the rotation velocity U3 and the horizontal moving velocity V3 were the same, the exfoliating angle θ is uniformly maintained. If the rotation velocity U3 is controlled to be greater than the horizontal moving velocity V3, the exfoliating angle θ is gradually increased. Advantageously, a total time of the exfoliating process may be reduced by controlling the horizontal moving velocity V3 as well as the rotation velocity U3. For example, after passing the position M, since the area of the polarizer 12 attached to the liquid crystal panel 10 is gradually reduced, even if the horizontal moving velocity V3 is increased, tearing of the polarizer 12 is not significantly generated.

As above described in the illustrated embodiments, the exfoliating angle θ may be controlled by controlling the horizontal moving velocity and the rotation velocity of the exfoliating roller 131. Advantageously, tearing of the polarizer 12 and premature lifting of the liquid crystal panel 10 may be reduced or effectively prevented by controlling the exfoliating angle θ. Also, the total time of the exfoliating process may be reduced by controlling the horizontal moving velocity and the rotation velocity of the exfoliating roller 131.

In the illustrated embodiment of FIGS. 3-7, the horizontal moving velocities V1, V2, and V3 of the exfoliating roller 131 are uniformly maintained, and the rotation velocity of the exfoliating roller 131 is changed in the initial, intermediate, and final exfoliating steps to reduce or effectively prevent tearing of the polarizer 12 and undesirable lifting of the liquid crystal panel 10, and to minimize the total time of the exfoliating process. However, the rotation velocity of the exfoliating roller 131 may be uniformly maintained and the horizontal moving velocities V1, V2, and V3 may be changed in the initial, intermediate, and final exfoliating steps, and this will now be described in detail with the reference to the drawings.

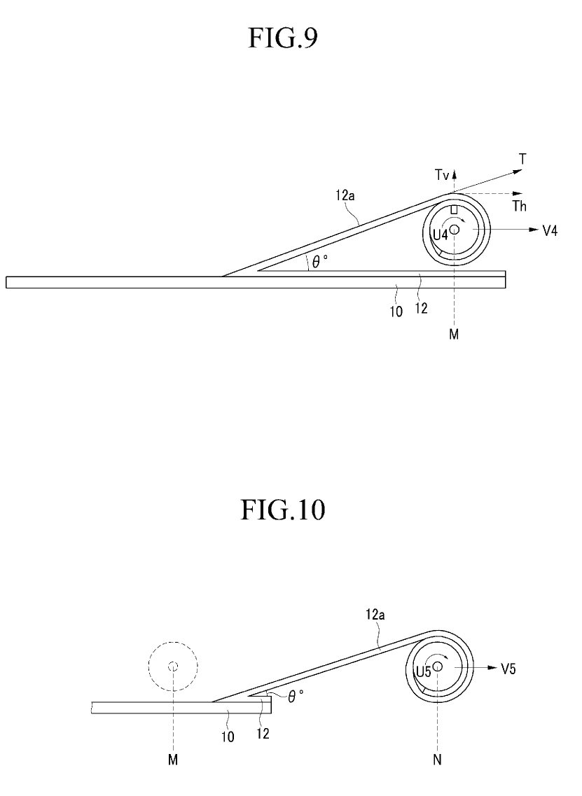

FIG. 9 and to FIG. 10 are views in sequence showing another exemplary embodiment of a method of removing a polarizer using a polarizer exfoliating roller of a polarizer remover according to the present invention.

An initial exfoliating step of the embodiment is substantially the same as the method of FIGS. 3-4 according to the previous embodiment. That is to say, referring to FIG. 3, the roller portion 130 of the polarizer remover 100 captures the edge of the polarizer 12, the exfoliating roller 131 is rotated with a prescribed rotation velocity U1, and the exfoliating roller 131 is simultaneously moved in the horizontal direction with a horizontal moving velocity V1, such that the polarizer 12 is exfoliated from the liquid crystal 10.

Referring to FIG. 4, the exfoliating roller 131 is continuously rotated and moved with the rotation velocity U1 and the horizontal moving velocity V1, respectively. Since the upper surface of the exfoliated polarizer 12a is contacted with the rear surface of the circumference of the exfoliating roller 131, and the rotation direction A of the exfoliating roller 131 is the same direction as the moving direction B of the exfoliating roller 131, the exfoliating angle θ is maintained at about 90 degrees. Advantageously, the tension T applied to the exfoliated polarizer 12a may be minimized such that the exfoliated polarizer 12a is not significantly torn.

Referring to FIG. 9, the horizontal moving velocity V4 of the exfoliating roller 131 in the intermediate exfoliating step is increased to be larger than the horizontal moving velocity V1 of the initial exfoliating step (FIG. 4), and the polarizer 12 is exfoliated. In an exemplary embodiment, it is preferable that the rotation velocity U4 of the intermediate exfoliating step is substantially the same as the rotation velocity U1 of the initial exfoliating step. Accordingly, the exfoliating angle θ in the intermediate exfoliating step is smaller than the exfoliating angle θ in the initial exfoliating step.

The exfoliating angle θ in the intermediate exfoliating step is minimized until a portion of the exfoliating roller 131 arrives at the position M corresponding to the right lower edge 10a (FIG. 8) or the right lower corner 10b (FIG. 8) of the liquid crystal panel 10. Since the exfoliating angle θ in the intermediate exfoliating step is smaller than the exfoliating angle θ in the initial exfoliating step, the horizontal tension component Th is increased and the vertical tension component Tv is reduced in the tension T applied to the polarizer 12. That is to say, the horizontal tension component Th is increased in comparison to the vertical tension component Tv which undesirably lifts the liquid crystal panel 10. Advantageously, the problem of premature lifting of the liquid crystal panel 10 due to reduction of the absorption force of the absorption holes 1 is reduced or effectively prevented. If the exfoliating angle θ is significantly small, the tension T applied to the polarizer 12 may cause tearing of the polarizer 12. In an exemplary embodiment, it is preferable that the exfoliating angle θ is reduced until just before tearing of the polarizer 12 occurs.

Furthermore, since the exfoliating roller 131 is moved with a horizontal moving velocity V4 greater than the horizontal moving velocity V1 of the initial exfoliating step (FIG. 4), a total time of the exfoliating process may be reduced.

Referring to FIG. 10, after passing the position M where the absorption force of the absorption holes 1 is reduced, the rotation velocity U5 of the exfoliating roller 131 in the final exfoliating step is maintained to be the same as the rotation velocity U4 of the intermediate exfoliating step, and the horizontal moving velocity V5 of the final exfoliating step is reduced smaller than the horizontal moving velocity V4 of the intermediate exfoliating step. If the horizontal moving velocity V5 of the exfoliating roller 131 in the final exfoliating step is maintained the same as the rotation velocity U5 of the final exfoliating step (e.g., the horizontal moving velocity V1 of the exfoliating roller 131 in the initial exfoliating step, FIG. 4), the exfoliating angle θ is uniformly maintained and the tension applied to the polarizer 12 is not increased. Advantageously, tearing of the polarizer 12 may be reduced or effectively prevented.

As in the illustrated embodiments of the polarizer remover according to the present invention, the rotation direction of the exfoliating roller is substantially the same as the moving direction of the exfoliating roller such that tearing of the polarizer may be reduced or effectively prevented when exfoliating the polarizer.

Furthermore in the illustrated embodiments, the exfoliating angle θ of the polarizer exfoliated from the liquid crystal panel is changed by controlling the rotation velocity and the moving velocity of the exfoliating roller, after an intermediate part of the exfoliating process, such that premature lifting of the liquid crystal panel may be reduced or effectively prevented.

Advantageously, since the polarizer is exfoliated without damaging the polarizer, productivity and exfoliate efficiency of the polarizer are improved.

Although exemplary embodiments of the present invention have been described in detail hereinabove, it should be clearly understood that many variations and/or modifications of the basic inventive concepts herein taught, which may appear to those skilled in the present art, will still fall within the spirit and scope of the present invention, as defined in the appended claims.

What is claimed is:

1. An apparatus for removing a polarizer of a liquid crystal display, the apparatus comprising:
a roller portion including a rotating exfoliating roller, and a gripping portion disposed on the exfoliating roller and gripping an edge of the polarizer; and
a roller moving portion exfoliating the polarizer from a liquid crystal panel, the roller moving portion rotating and moving the roller portion,
wherein the exfoliating roller rotates at a rotating velocity and moves at a moving velocity; and
wherein a rotating direction of the exfoliating roller is the same as a moving direction of the exfoliating roller.

2. The apparatus of claim 1, wherein an upper surface of the exfoliated polarizer is contacted with a rear surface of an outer circumference of the exfoliating roller with reference to the moving direction of the exfoliating roller.

3. The apparatus of claim 2, wherein an exfoliating angle is defined as an angle between the exfoliated polarizer and the polarizer attached to the liquid crystal panel, and
wherein the roller moving portion controls the exfoliating angle through adjustment of the rotating velocity and the moving velocity.

4. The apparatus of claim 3, further comprising:
a stage portion disposed under the liquid crystal panel and fixing the liquid crystal panel,
wherein the stage portion includes a plurality of openings disposed under the liquid crystal panel fixing the liquid crystal panel.

5. A method of removing a polarizer of a liquid crystal display, the method comprising:
rotating and horizontally moving an exfoliating roller, and exfoliating a polarizer from a liquid crystal panel at a first exfoliating angle, the exfoliating roller rotating in a rotating direction at a rotating velocity, and moving in a moving direction at a horizontal moving velocity;
controlling the rotating velocity and the horizontal moving velocity, and exfoliating the polarizer from the liquid crystal panel at a second exfoliating angle, the second exfoliating angle being less than the first exfoliating angle; and
maintaining a third exfoliating angle, and exfoliating the polarizer from the liquid crystal panel, the third exfoliating angle being substantially the same as the second exfoliating angle,
wherein the rotating direction of the exfoliating roller is the same as the moving direction of the exfoliating roller.

6. The method of claim 5, wherein an upper surface of the exfoliated polarizer is contacted with a rear surface of an outer circumference of the exfoliating roller with reference to the moving direction of the exfoliating roller.

7. A method of removing a polarizer attached to a liquid crystal display, the method comprising:
rotating an exfoliating roller with a first rotating velocity, moving the exfoliating roller with a first horizontal moving velocity, and exfoliating a polarizer from a liquid crystal panel;
rotating the exfoliating roller with a second rotating velocity smaller that the first rotating velocity, moving the exfoliating roller with a second horizontal moving velocity, and exfoliating the polarizer from the liquid crystal panel; and
rotating the exfoliating roller with a third rotating velocity greater that the second rotating velocity, moving the exfoliating roller with a third horizontal moving velocity, and exfoliating the polarizer from the liquid crystal panel by.

8. The method of claim 7, wherein the first, the second and the third horizontal moving velocity are equal to each other.

9. The method of claim 8, wherein the second rotating velocity is slower than the second horizontal moving velocity of the exfoliating roller.

10. The method of claim 9, wherein an exfoliating angle is defined as an angle between the exfoliated polarizer and the polarizer attached to the liquid crystal panel,
wherein the exfoliating angle of the exfoliating step at the second rotating velocity is reduced from the exfoliating angle of the exfoliating at the first rotating velocity.

11. The method of claim 9, wherein the second rotating velocity is about zero.

12. The method of claim 9, wherein the first and third rotating velocities are the same as the first, the second and the third horizontal moving velocity of the exfoliating roller.

13. A method of removing a polarizer of a liquid crystal display, the method comprising:
a first exfoliating of a polarizer from a liquid crystal panel, the first exfoliating including moving an exfoliating roller with a first horizontal moving velocity and a first rotating velocity;
a second exfoliating of the polarizer from the liquid crystal panel, the second exfoliating including moving the exfoliating roller with a second rotating velocity, and a second horizontal moving velocity greater than the first horizontal moving velocity; and
a third exfoliating of the polarizer from the liquid crystal panel, the third exfoliating including moving the exfoliating roller with and a third rotating velocity, and a third horizontal moving velocity slower than the second horizontal moving velocity.

14. The method of claim 13, wherein the first, the second and the third rotating velocity are equal.

15. The method of claim 14, wherein the second horizontal velocity is greater than the first, the second and the third rotating velocity of the exfoliating roller.

16. The method of claim 15, wherein an exfoliating angle is defined as an angle between the exfoliated polarizer and the polarizer attached to the liquid crystal panel,
wherein an exfoliating angle of the second exfoliating is reduced from an exfoliating angle of the first exfoliating.

17. The method of claim 15, wherein the first and third horizontal moving velocities are the same as the first, the second and the third rotating velocity of the exfoliating roller.
